(19) United States
(12) Patent Application Publication
(10) Pub. No.: US 2005/0207470 A1
(43) Pub. Date: Sep. 22, 2005

(54) Focusing thermometer

(76) Inventors: Timothy J. Bennett, Fairfax, VA (US); Preyas Shah, Warrington, PA (US); William Lourie, Englewood, NJ (US); Marvin Hutt, Englewood, NJ (US); Richard K. Harris, West Chester, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/043,360

(22) Filed: Jan. 26, 2005

Related U.S. Application Data
(60) Provisional application No. 60/539,228, filed on Jan. 26, 2004.

(51) Int. Cl. G01J 5/00

(52) U.S. Cl. 374/130

(57) ABSTRACT

A sensor assembly for measuring temperature at a target location includes a sensor adapted to detect infrared radiation and produce an electrical output. A focusing lens focuses infrared radiation from the target location onto the sensor while substantially preventing infrared radiation from points outside the target location from being detected by the sensor. In a first embodiment, a sensor assembly for a focusing thermometer includes a sensor and a focusing lens. In a second embodiment, a focusing thermometer for measuring temperature at a target location includes a sensor assembly and electronic circuitry that receives electrical output from the sensor assembly and processes the output into a temperature reading. The sensor assembly includes a focusing lens for focusing infrared radiation from the target location onto the sensor while substantially preventing infrared radiation from points outside the target location from being detected by the sensor.

### RELATED APPLICATIONS

Pursuant to 35 U.S.C. § 119, this application claims the benefit of U.S. Provisional Application No. 60/539,228, filed Jan. 26, 2004, the entire disclosure of which is incorporated herein by reference.

### FIELD OF THE INVENTION

The invention relates generally to a device which measures temperature of an object, such as a thermometer. More particularly, the invention relates to a system and method for measuring temperature using an infrared detector, without having contact with the object.

### BACKGROUND

A common technique for measuring body temperature is through the sensing of infrared (IR) energy from one or more locations on the body. This technique, referred to as “non-contact” thermometry, can be used to measure body temperature in locations that are too confined and/or delicate to allow for direct contact between the body part and a temperature probe. A common example is the tympanic membrane in the inner ear.

The typical infrared thermometer has a probe tip with at least one opening or window at the front of the probe tip. The opening collects IR energy from an object of interest and directs the energy to an IR sensor. The IR sensor outputs a signal based on the IR energy emitted from the object of interest. The output signal is governed by the Stefan-Boltzmann law, which relates energy to the fourth power of temperature difference between the object of interest and the sensor. The output signal from the sensor is electronically and statistically conditioned and adjusted with an offset and gain to calculate a temperature reading for the object of interest. The adjusted temperature calculation is then displayed to the user.

The accuracy and performance of clinical thermometers are affected by many variables. Many IR thermometers employ a very narrow speculum or probe tip that permits the thermometer to be placed in confined spaces, such as the ear canal. The IR sensor, which is too large to be placed in the probe tip, is positioned a significant distance back from the probe tip. Therefore, the IR sensor is not situated at the opening where IR radiation enters the probe. IR radiation must be conveyed to the sensor by an optical waveguide. The waveguide propagates the IR radiation by reflection or refraction until the radiation reaches the sensor. This has the undesirable effect of allowing IR energy to be absorbed in the wave guide. The energy losses can lead to an inaccurate temperature measurements. Waveguides that reflect IR radiation are also prone to surface contamination which can diminish reflectivity, leading to additional energy losses.

IR thermometers also include wide viewing apertures to measure IR radiation from a wide field of view. This is not desirable when IR radiation must be measured from a relatively small target area. In the ear, for example, the temperature of the tympanic membrane is believed to be the most accurate reflection of a patient's core body temperature, as compared to other points in the ear. Temperature within the ear canal can vary significantly from point to point, and temperatures at some locations can differ by 4° F. or more. Dramatic differences in temperature may be found between locations near the ear opening and locations at the interior of the ear canal. Therefore, it is desirable to limit temperature measurements to areas on or immediately adjacent to the tympanic membrane. IR thermometers that sense IR radiation from a wide field of view tend to take extraneous measurements from a wide area having significant temperature variations. These extraneous measurements may be associated with temperatures that deviate significantly from the temperature of the tympanic membrane, leading to a skewed temperature reading. As a result, IR thermometers that sense IR radiation from a wide field of view have limited accuracy.

Some devices that collect IR energy from the ear canal over a wide field of view condition the signal and add a statistical offset to compensate for the errors inherent in measuring IR energy over a wide field of view in the ear canal. Statistical offsets have limited effectiveness in correcting errors, however. Each individual's ear canal is unique, and creates its own set of variables that affect the measurement of IR energy. In addition, different operators use different techniques when operating the IR thermometer, creating inconsistencies in temperature measurement. Therefore, developing a statistical offset introduces an inherent margin of error, since user techniques and the patient's physiology can affect the actual amount of error introduced into the calculation. As a result, thermometers presently used to detect IR energy leave much to be desired in terms of accuracy and performance.

### SUMMARY OF THE INVENTION

A device in accordance with the present invention includes a sensor assembly for measuring temperature at a target location that emits infrared radiation. The sensor assembly includes a sensor adapted to detect infrared radiation and produce an electrical output, and a focusing lens for focusing infrared radiation from the target location onto the sensor while substantially preventing infrared radiation from points outside the target location from being detected by the sensor.

In a first embodiment, a sensor assembly for a focusing thermometer includes a sensor and a focusing lens. The sensor assembly is operable to measure temperature at a target location that emits infrared radiation. The sensor detects infrared radiation and produces an electrical output. The focusing lens focuses infrared radiation from the target location onto the sensor while substantially preventing infrared radiation from points outside of the target location from being detected by the sensor.

In a second embodiment, a focusing thermometer for measuring temperature at a target location includes a sensor assembly and electronic circuitry that receives electrical output from the sensor assembly and processes the output into a temperature reading. The sensor assembly includes a sensor that detects infrared radiation and produces an electrical output, and a focusing lens for focusing the infrared radiation from the target location onto the sensor while substantially preventing infrared radiation from points outside the target location from being detected by the sensor. The electronic circuitry receives the electrical output from the sensor and processes the output into a temperature reading.

### DESCRIPTION OF THE DRAWINGS

The foregoing summary as well as the following detailed description will be better understood when read in conjunction with the drawing figures, in which:

FIG. 1 is a block diagram of components in a focusing thermometer in accordance with the present invention.

FIG. 2 is a right side view of a focusing thermometer in accordance with the present invention.

FIG. 3 is a left side cross section view of the focusing thermometer of FIG. 2.

FIG. 4 is a front elevation view of the focusing thermometer of FIG. 2.

FIG. 5 is a cross section view of the focusing thermometer of FIG. 2 viewed from line 5-5 in FIG. 2.

FIG. 6 is a rear elevation view of the focusing thermometer of FIG. 2.

FIG. 7 is an enlarged perspective view of sensing components in accordance with the present invention, with a section broken away to show internal components.

FIG. 8 is an enlarged, truncated side cross-section view of sensing components of the focusing thermometer of FIG. 2, illustrating aspects of the thermometer's operation.

### DETAILED DESCRIPTION OF THE INVENTIONS

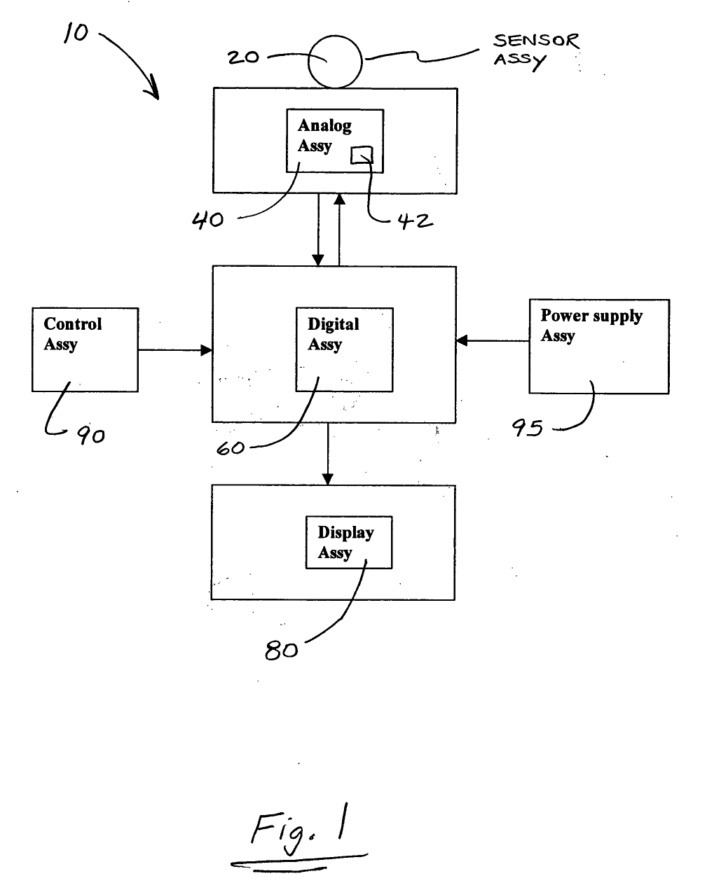

Referring to the drawing figures in general, and to FIG. 1 in particular, a block diagram of a focusing thermometer 10 is shown in accordance with the present invention. The focusing thermometer 10 is used to measure and record body temperature from a specific location inside a cavity, orifice or other confined space within a body, such as the ear, mouth and rectum. The components of the IR thermometer detect and measure IR radiation from a specific location on the body, rather than a wide field of view. This facilitates accurate prediction of body temperature and avoids the need for statistical offsets and other adjustments, which can contribute error.

The focusing thermometer 10 includes a sensor assembly 20 configured to collect infrared radiation and produce an electrical output signal. The sensor assembly 20 is connected with an analog assembly 40 which receives the output signal. One or more components, such as a signal amplifier 42, may be integrated with the analog assembly 40 to condition the output signal from the sensor assembly 20. The analog assembly 40 is connected with a digital assembly 60. The digital assembly 60 includes a converter 62 that receives the output signal and converts it from an analog signal to a digital signal. The digital signal is then processed to generate a temperature calculation.

The digital assembly 60 is connected to a display assembly 80, which receives output from the digital assembly and displays an output value, such as a temperature reading. The IR thermometer 10 also includes a control assembly 90 containing one or more switches operable to control the thermometer's operation. An electric power supply 95 supplies to power the thermometer components.

As stated earlier, the focusing thermometer of the present invention may be used for taking temperature measurements from a variety of locations, such as the ear, mouth and rectum. The specific configuration of the thermometer is not germane to the present invention, and may be designed for a specific application. For purposes of this description, the focusing thermometer of the present invention will be described and illustrated as an IR ear thermometer. It will be appreciated that the present invention is not limited to ear thermometers, since the principles of operation apply equally well to other parts of the body. Moreover, the terminology used in connection with the present invention is used for merely description, not limitation.

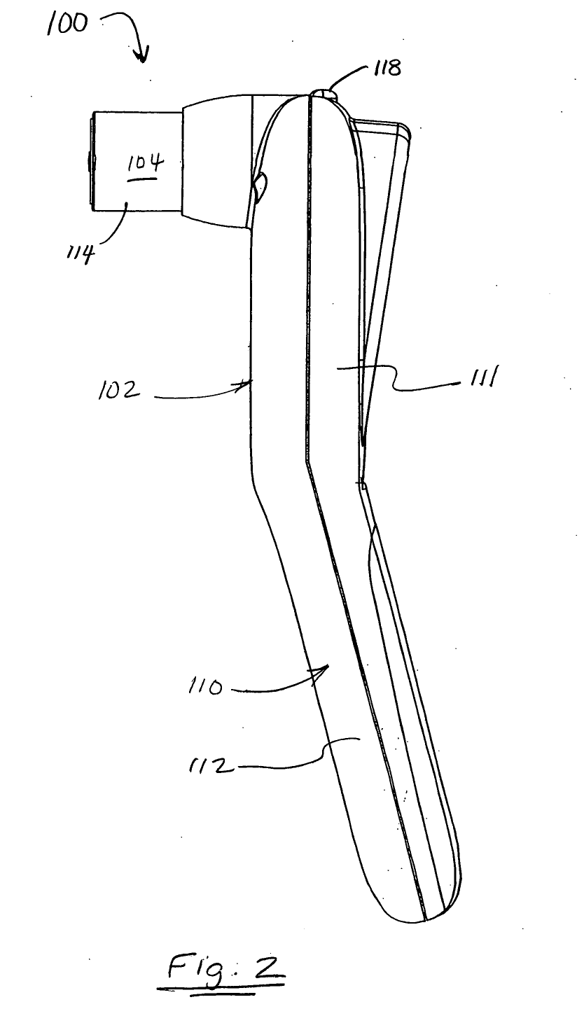

Referring now to FIG. 2, a portable IR focusing thermometer 100 is shown in accordance with the present invention. The focusing thermometer 100 is a hand held instrument that includes an elongate housing 102. The housing 102 has a probe portion 104 and a handle portion 110 that extends from the probe portion in a transverse orientation. The handle portion 110 may incorporate a variety of designs with or without ergonomic features. In FIG. 2, the handle portion 110 includes a central portion 111 extending generally perpendicularly from the probe portion 104, and a longer angled portion 112. The longitudinal axis of the angled portion 112 is canted slightly from the axis of the central portion, providing an angularly offset section that extends away from the patient when the focusing thermometer 100 is being inserted into the patient's ear. In this arrangement, the user can insert the distal end 106 of the thermometer into the patient's ear, while keeping the handle spaced a comfortable distance away from the patient.

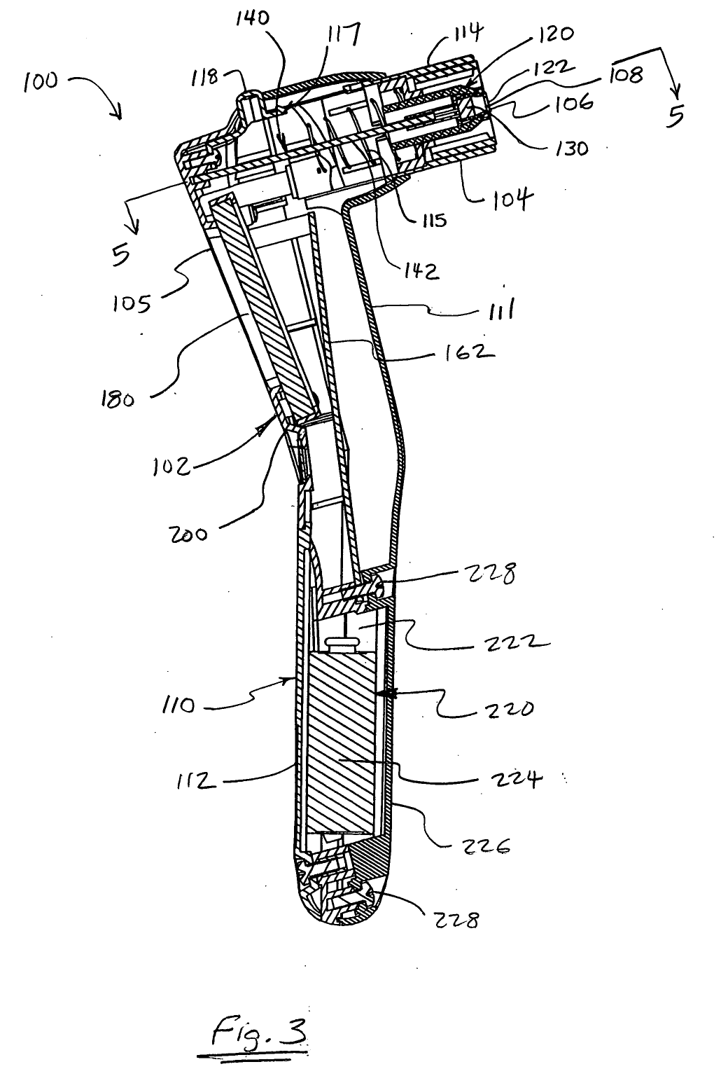

Referring now to FIG. 3, the probe portion 104 houses a sensor assembly or probe 120 that extends outwardly and away from the handle portion 110. The sensor assembly has a distal end 106 that forms a generally circular opening or aperture 108. An IR sensor 130 is disposed inside the sensor assembly 120 and extends more or less in coaxial alignment with the aperture 108. The sensor assembly 120 connects with an analog assembly 140 that extends from the probe portion 104 and into the handle portion 110. The analog assembly 140 includes an analog board 142 that extends from the sensor assembly 120 and connects with a digital assembly 160 extending in the handle portion 110. The digital assembly 160 includes a digital board 162 having an analog to digital converter.

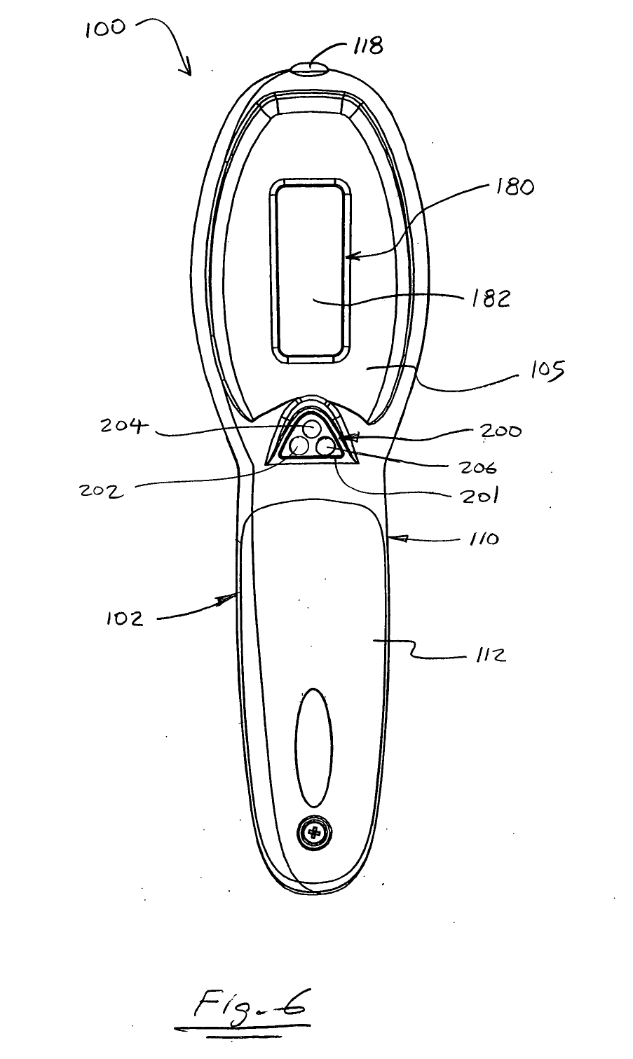

Referring now to FIGS. 3 and 6, the housing 102 has a rear face 105 that extends along the central portion 111 of the handle 110. The rear face 105 has a display assembly or interface 180 oriented to face the user of the thermometer 100 when the thermometer is inserted into the patient's ear. The display assembly 180 connects with the digital assembly 160 and includes one or more audio or visual display components, such as a display screen, LED light or speaker. In FIG. 3, the display assembly 180 includes an LCD screen. A variety of other display technologies may be used, including but not limited to PLED or OLED displays.

The IR thermometer 100 performs a number of functions and operates in different modes that can be selected and controlled by the user. A control assembly 200 extends along the exterior of the housing and is operable to change the function or mode of operation of the thermometer 100. In FIG. 6, the control assembly 200 extends along the rear face 105 beneath the display assembly 180. The control assembly 200 includes a control pad 201 positioned just above the angled portion 112 of the handle 110. In this position, the operator can grasp the angled portion 112 in either hand, with the thumb on that hand in close proximity to the control pad 201 to permit the thermometer 100 to be operated with one hand. Since the control pad 201 is located beneath the display screen 182, the operator's thumb does not obstruct the display screen when the control pad is in use.

The control assembly 200 contains one or more switches operable to control a different function or mode of operation. In FIG. 6, the control pad 201 includes a first switch 202, second switch 204 and third switch 206. The first switch 202 activates a temperature measurement mode. The second switch 204 activates a temperature recall mode, which displays a temperature previously taken by the thermometer 100. The third switch 206 activates a counter or timer function, which may be used by a practitioner to monitor elapsed time for taking a pulse, or other procedure. The counter is connected to a signaling device, such as a speaker or LED, to notify the practitioner when the specified time has elapsed.

The focusing thermometer 100 is connected with a source of power to operate the sensor assembly 120, display assembly 160 and other components. The source of power may be a power cord or adapter attachable to a wall socket. Alternatively, the thermometer 100 may be powered by a battery pack. Referring now to FIGS. 3 and 4, the thermometer 100 has a power supply assembly 220 in the handle portion 110. A compartment 222 in the handle portion 110 is adapted to receive a battery pack 224. The housing 102 has an access panel 226 that is removable to provide access to the compartment 222. The access panel 226 is connected to the housing 102 with screws 228 or comparable fasteners to secure the battery pack 224 in the handle 110. As an alternative to fasteners, the access panel 226 may have one or more tabs molded on the access panel that engage corresponding slots on this housing 102.

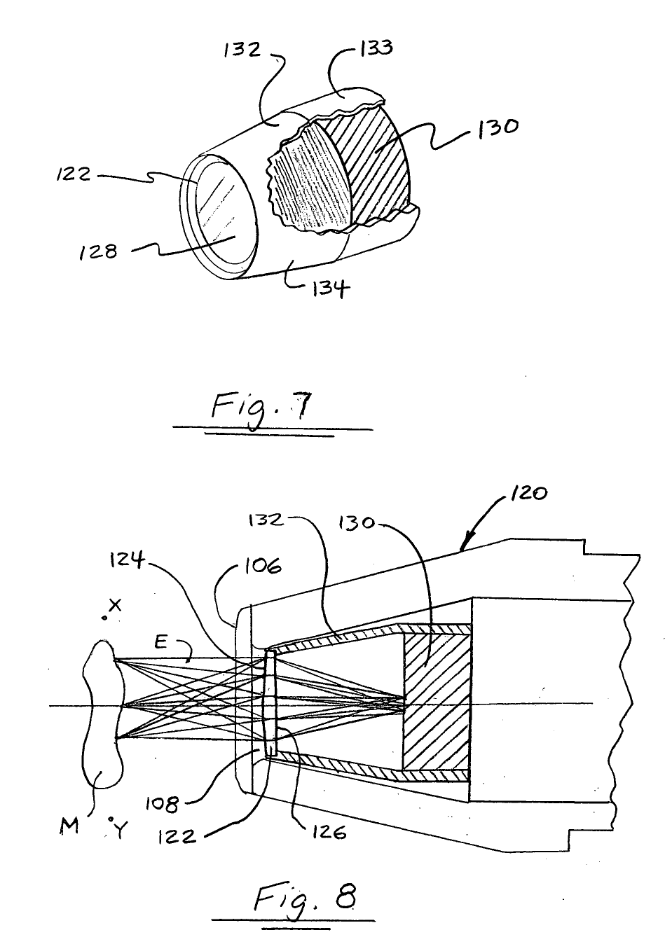

Referring now to FIGS. 3, 7 and 8, the sensor assembly 120 will be described in greater detail. The sensor assembly 120 is operable to detect IR radiation emitted from a specific area or target, while ignoring IR radiation from points outside the specific area or target. This is accomplished by a focusing apparatus that refracts IR rays from the target location onto the IR sensor 130. The focusing apparatus includes one or more optical components having an effective focal length for projecting IR rays from the tympanic membrane onto the IR sensor 130. In FIGS. 7 and 8, a single focusing lens 122 is shown in the thermometer 100. The focusing lens 122 is centrally positioned in the sensor assembly 120 at the distal end 106 and has a central or principal axis 123 extending coaxially with the central axis of the IR sensor 130.

The focusing lens 122 has an outer face 124 that faces outwardly toward the aperture 108, and an inner face 126 that faces inwardly toward the IR sensor 130. The outer face 124 of the focusing lens may contain one or more coatings to modify or enhance properties of the lens. The lens does not require coatings, however. In FIG. 9, the outer face 124 has an anti-reflective coating 128 to reflect certain wavelengths. The geometry of the lens 122 is highly dependent on the target position and the desired focal length of the lens. The desired focal length depends largely on the dimensions of the patient's ear canal, which change with age. Testing in infants and toddlers has revealed the need for a shorter focal length, while testing in adults has revealed the need for a much longer focal length. Studies have shown that a focal length between 4-13 mm is appropriate for infants and toddlers, while a focal length between 18-25 mm is appropriate for adults. Focal lengths outside of these ranges can also yield acceptable temperature measurements.

The IR sensor 130 is positioned a specified distance behind the lens 122 to directly receive refracted IR rays from the target location. The distance between the back of the focusing lens 122 and the front of the IR sensor 130 is based on the principle of maximizing the amount of IR energy impinging on the IR sensor from a target location. The distance between the lens 122 and the sensor 130 is very small, typically a few millimeters. In this arrangement, the IR rays from the target location are focused through the lens and refracted directly onto the IR sensor without being bounced multiple times through a waveguide. Since the IR rays are not bounced through a waveguide, the IR energy is projected directly onto the IR sensor without substantial energy loss. A number of thermal detectors and transducers may be used for the IR sensor 130. For example, a mini-thermopile manufactured by H. L. Planar Technology GmbH or other manufacturer may be used as the sensor 130. The mini-thermopile is a relatively small component, less than 10 mm in diameter, and allows for placement of the IR sensor 130 at or near the distal end 106 of the sensor assembly 120. In this configuration, the focusing lens 122 and IR sensor 130 are positioned at the outermost end of the probe, so that bends in the ear canal do not obstruct the optical path between the sensor and the point of measurement.

The focusing lens 122 and IR sensor 130 are interconnected by a bridge component that stabilizes the position of the lens relative to the sensor. In FIGS. 7 and 8, the lens 122 and IR sensor 130 are shown interconnected by a collar 132. The collar 132 is formed of a thermo-conductive material, such as brass, to maintain the lens and sensor at or very close to thermal equilibrium. The thermal conductance of the collar 132 is much greater than the thermal conductance of ambient air surrounding the distal end 106. In this arrangement, the thermal equilibrium between the lens 122 and sensor 130 minimizes radiation heat transfer from the collar or lens to the sensing assembly. If significant radiation hear transfer is allowed to take place, the perceived temperature of the target location can be affected.

The collar 132 has a cylindrical portion 133 that surrounds the IR sensor 130, and a tapered frusto-conical portion 134 that surrounds the focusing lens 122. The focusing lens 122 and IR sensor 130 may be connected with the collar 132 by press-fitting the components into the collar, or by using epoxy or other suitable attachment means. The IR sensor is connected to the analog board 142 by soldering or other suitable connection means.

The ear canal has multiple curvatures, providing a twisting path from the ear opening to the tympanic membrane. The thermometer 100 may include a curved probe tip that conforms to the natural curvatures in the ear canal.

The IR thermometer of the present invention may incorporate a number of guards and covers to protect the sensor assembly from damage and contamination. Referring to FIGS. 2, 3 and 5, the sensor assembly 120 is protected inside the probe portion 104 by a retractable outer cover or ring 114. The outer cover 114 is connected to the housing 102 in a telescoping arrangement, which permits the outer cover to be slidably displaceable between an extended position and a retracted position. In the extended position, shown in FIG. 2, the outer cover 114 extends over the sensor assembly 122 to protect the sensor components against shock or contamination from contact with other objects. In the retracted position, the outer cover 114 is displaced rearwardly into the housing 102.

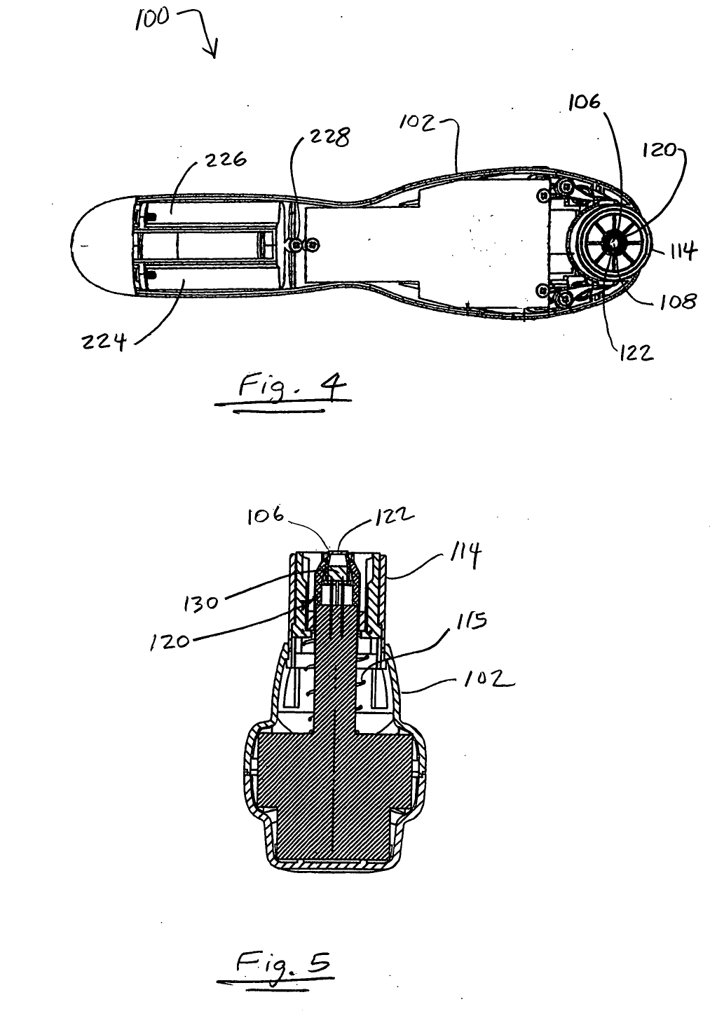

The housing 102 includes a biasing element that normally biases the outer cover 114 toward the extended position. In FIGS. 3 and 5, the biasing element is shown as a compression spring 115. In the retracted position, the outer cover 114 is displaced rearwardly into the housing 102 against the bias of the compression spring 115. This exposes the sensor assembly 120 to allow placement of a probe cover over the sensor assembly. The outer cover 114 is retained in the retracted position against the bias of the spring 115 by a latch 117, which engages the outer cover. One or more release buttons 118 are connected with the latch 117 and project from the exterior of the housing 102. The release button or buttons 118 are operable to disengage the latch 117 from the outer cover 114, allowing the biasing element 115 to propel the outer cover over the sensor assembly and into the extended position.

Referring to FIGS. 3 and 8, the operation of the IR thermometer 100 will now be described. The instrument is prepared for use in accordance with approved methods. The outer cover 114 is retracted into the housing and a disposable transparent probe cover is placed over the sensor assembly 120. Power is switched on, and the first switch 202 on the control pad 201 is depressed to select the temperature measurement mode. The distal end 106 of the sensor assembly 120 is inserted into the patient's ear opening and advanced into the ear canal until the aperture 108 is positioned near the tympanic membrane, which is represented by “M”. In this position, the sensor assembly 120 is oriented with the aperture 108 facing toward membrane M and the lens 122 is focused on membrane M.

IR rays emitted from membrane M, which are represented by the lines labeled “E”, are passed through the focusing lens 122 and projected directly onto the IR sensor 130. The IR sensor 130 is positioned behind the lens at the proper distance relative to the focal length of the lens to only receive IR rays from membrane M. That is, the focusing lens 122 and IR sensor 130 are arranged to only measure IR radiation from the target area onto membrane M. IR rays emitted from points “X” and “Y” in FIG. 9 are outside of the target area and therefore are not refracted by the focusing lens onto the IR sensor. The large majority of IR energy from points outside of the target area are reflected directly away by the focusing lens 122 or redirected away by the lens. Accordingly, the IR sensor only produces an output signal based almost exclusively on the energy measured at membrane M.

With the handle portion 110 grasped and held steady in one hand, the first switch 202 is activated on the control pad 201 to take a temperature reading from the tympanic membrane M. If desired, separate switches may be provided for selecting the temperature measurement mode and initiating the actual temperature measurement. The IR thermometer may be operated in a scan mode, which takes multiple readings from the target area, or a “single view” mode, which takes a single temperature measurement. The IR sensor produces an output signal based on the IR radiation emitted from membrane M. Once the output signal is produced by the IR sensor 130, the signal is amplified by the analog assembly 140 and sent to the digital assembly 160. The signal is converted from an analog signal to a digital signal that can be processed.

During digital processing, the digital signal received from the converter is compared with a reformulation of ratio of energy in the IR band with the total radiation, using the Planck distribution formula and Stefan-Boltzmann law, to generate the perceived temperature of the object of interest. Since the IR sensor is focused on membrane M, as opposed to a wide field of view within the ear canal, the energy on the sensor assembly is directly related to the spot temperature of the membrane M. As a result, there is no need to introduce a statistical offset or error correction to account for the large variations of temperature within the ear. The digital assembly sends the processed signal to the display assembly, where the temperature of membrane M is conveyed to the thermometer user.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. For example, the IR thermometer may include components that utilize optical grating and/or amplification to refine energy measurements. Accordingly, the invention incorporates variations that fall within the scope of the following claims.

1. A focusing thermometer for measuring temperature at a target location that emits infrared radiation, said thermometer having a distal tip and comprising:
A. a sensor assembly, comprising:
(1) a sensor adapted to detect infrared radiation and produce an electrical output; and
(2) a focusing lens for focusing the infrared radiation from the target location onto the sensor while substantially preventing infrared radiation from points not at said target location from being detected by said sensor; and
B. electronic circuitry adapted to receive the electrical output from the sensor and process the output into a temperature reading.

2. The clinical thermometer of claim 1, comprising an analog assembly in electrical communication with the sensor assembly.

3. The clinical thermometer of claim 2, comprising a digital assembly in electrical communication with the analog assembly, said digital assembly comprising an analog to digital converter operable to convert the electrical output into a digital signal.

4. The clinical thermometer of claim 3, comprising a display assembly.

5. The clinical thermometer of claim 1, wherein the sensor comprises a mini-thermopile.

6. The clinical thermometer of claim 1, wherein the focal length of the lens is between approximately 4 mm and 25 mm.

7. The clinical thermometer of claim 1, wherein the sensor assembly comprises a thermo-conductive collar disposed around the sensor and the focusing lens.

8. The clinical thermometer of claim 7, wherein the sensor and the focusing lens are bonded to the thermo-conductive collar.

9. The clinical thermometer of claim 1, comprising a control assembly having one or more switches operable to toggle the thermometer between different modes of operation.

10. The clinical thermometer of claim 9, comprising a first switch that actuates a temperature measurement mode.

11. The clinical thermometer of claim 10, comprising a second switch that actuates a temperature recall function.

12. The clinical thermometer of claim 11, comprising a third switch that actuates a timer.

13. The clinical thermometer of claim 1 comprising a power supply.

14. The clinical thermometer of claim 1 wherein the lens and the sensor are located at the distal tip of the thermometer.

15. The clinical thermometer of claim 1 wherein the lens has a diameter of between approximately 5 mm and 5.5 mm.

16. The clinical thermometer of claim 1 comprising an anti-reflective coating on the lens.

17. A sensor assembly for a focusing thermometer operable to measure temperature at a target location that emits infrared radiation, said sensor assembly comprising:
A. a sensor adapted to detect infrared radiation and produce an electrical output; and
B. a focusing lens for focusing infrared radiation from the target location onto the sensor while substantially preventing infrared radiation from points not at said target location from being detected by said sensor.

18. The sensor assembly of claim 17, wherein the sensor comprises a thermopile.

19. The sensor assembly of claim 17, wherein the focal length of the lens is between 4 mm and 25 mm.

20. The sensor assembly of claim 17 comprising a bridge component that interconnects the sensor and the focusing lens.

21. The sensor assembly of claim 20, wherein the bridge component comprises a thermo-conductive collar disposed around the sensor and the focusing lens.

22. The sensor assembly of claim 21, wherein the sensor and the focusing lens are bonded to the thermo-conductive collar.

23. A device for measuring temperature at a target location that emits infrared radiation, said device comprising a sensor assembly, said sensor assembly comprising a sensor adapted to detect infrared radiation and produce an electrical output, and a focusing lens for focusing infrared radiation from the target location onto the sensor while substantially preventing infrared radiation from points outside said target location from being detected by said sensor.
